(19) United States
(12) Patent Application Publication
(10) Pub. No.: US 2023/0279300 A1
(43) Pub. Date: Sep. 7, 2023

(54) Process and Plant for Obtaining Hydrocarbons

(71) Applicant: LINDE GMBH, Pullach (DE)

(72) Inventors: Torben Hofel, Munchen (DE); Josef Kunkel, Pullach (DE)

(21) Appl. No.: 18/005,668

(22) PCT Filed: Jul. 16, 2021
(86) PCT No.: PCT/EP2021/069967

§ 371 Date: Jan. 16, 2023

(30) Foreign Application Priority Data
Jul. 17, 2020 (EP) 20186559.9
Nov. 13, 2020 (EP) 20207386.2

(51) Int. Cl. C10G 47/22

(52) U.S. Cl. CPC C10G 47/22; C10G 2300/4006; C10G 2300/4012; C10G 2400/02

(57) ABSTRACT

A process for producing hydrocarbons includes providing a component mixture containing hydrocarbons and a feed mixture containing hydrocarbons having two or more carbon atoms and lower boiling compounds using a portion of the component mixture, and forming a heavy fraction and a light fraction using the feed mixture. The heavy fraction contains a portion of the hydrocarbons from the feed mixture and is at least poor in the lower boiling components. The light fraction contains a portion of the lower boiling components from the feed mixture and is at least poor in the hydrocarbons from the feed mixture. The heavy fraction and a first intermediate fraction are formed using some of the feed mixture in low-temperature separation. Some of the first intermediate fraction is subjected to non-cryogenic separation while obtaining the light fraction and a second intermediate fraction. A portion of the second intermediate fraction is recycled to the process.

### CROSS-REFERENCE TO RELATED APPLICATIONS

This application is the national phase of, and claims priority to, International Application No. PCT/EP2021/069967, filed Jul. 16, 2021, which claims priority to European Application No. 20186559.9, filed Jul. 17, 2020, and European Application No. 20207386.2, filed Nov. 13, 2020.

### FIELD OF THE INVENTION

The invention relates to a process for the production of hydrocarbons and to a corresponding plant.

### BACKGROUND OF THE INVENTION

Processes and plants for steam cracking hydrocarbons are described, for example, in the article “Ethylene” in Ullmann’s Encyclopedia of Industrial Chemistry, online edition, Apr. 15, 2009, DOI: 10.1002/14356007.a10_045.pub2. Steam cracking (in German also referred to as “Dampfspalten”) is mainly used for the production of short-chain olefins such as ethylene and propylene, diolefins such as butadiene, or aromatics, but is not limited to the production of such compounds.

Steam cracking yields component mixtures (also referred to as cracked gases or raw gases) that are subjected to suitable processing sequences to recover the desired individual components. Typically, the front-end section of a corresponding treatment sequence involves the removal of heavy compounds, if any, followed by a so-called raw gas compression and acid gas removal. After processing in the front-end section, a fractionation process takes place, in which different fractions are formed by thermal separation processes and are further separated as required. For details, please refer to the mentioned article “Ethylene” in Ullmann’s Encyclopedia of Industrial Chemistry, particularly Sections 5.3.2.1, “Front-End Section,” and 5.3.2.2, “Hydrocarbon Fractionation Section.”

In one embodiment of corresponding fractionation, which can also be used in connection with the invention, hydrocarbons having two carbon atoms and lower-boiling components such as methane and hydrogen are initially separated from hydrocarbons having three carbon atoms and higher-boiling compounds in fractionation. Such a step is usually also referred to as deethanization, the design of corresponding fractionation is referred to as a “deethanizer-first” or “front-end deethanizer” process.

The fraction of hydrocarbons having two carbon atoms and lower boiling components obtained in gaseous form in deethanization can be fed to a further separation, in which the hydrocarbons having two carbon atoms are separated from the also contained lower boiling components. Such a step is also called demethanization. Thus, in a “deethanizer-first” or “front-end deethanizer” process, demethanization is downstream of deethanization.

In alternative processes, the deethanization and demethanization steps can also be performed in reverse order. This is then referred to as “demethanizer-first” or “front-end demethanizer” processes. Further process variants are described in the mentioned technical literature.

The invention relates to all processes and process variants with which a component mixture containing hydrocarbons having two carbon atoms and lower-boiling components, in particular methane and hydrogen, is used or obtained at any point in corresponding fractionation, and with which such component mixture, hereinafter also referred to as a “feed mixture,” is subjected to demethanization. Depending on the design of fractionation and in particular the use for steam cracking, the feed mixture can also contain smaller or larger amounts of higher boiling components, in particular hydrocarbons having three carbon atoms, hydrocarbons having four carbon atoms, and possibly also hydrocarbons having more than four carbon atoms of the usual type.

Typically, temperatures below -130° C. to -150° C. are required for sufficient separation of the hydrocarbons having two carbon atoms from the lighter components, irrespective of whether higher boiling components are also contained in a corresponding feed mixture, i.e. in demethanization, and comparatively complex separation apparatus is required, as explained in detail below.

EP 1 024 187 A1 relates to a process for recovering an ethylene-rich fraction by means of combined adsorption and rectification from an olefin-containing mixed fraction withdrawn from a cracking furnace, in particular from an ethylene cracked gas, wherein a fraction substantially containing H₂, CH₄ and CO is separated from the olefin-containing mixed fraction by adsorption or permeation, and then the fraction containing the remaining components is fed to the rectification process. There, a fuzzy C1/C2 separation takes place in rectification, and at least one fraction depleted in terms of C2 components is recycled upstream of the adsorptive or permeative separation stage. The adsorptive or permeative separation stage can be followed by at least one further adsorptive or permeative separation stage, wherein in this stage, a fraction rich in C2 components is separated from the fraction containing H₂, CH₄ and CO separated in the first separation stage. The process proposed here is to enable a reduction in the gas streams to be processed in the cold separation section and a cut-back of low-temperature demethanization, leading to an overall reduction in investment costs and refrigerant compressor capacity.

Processes for the treatment of gas mixtures are known from other technical fields, but they are not suitable for the treatment of gas mixtures from a steam cracking process, in particular under the boundary conditions explained below, or are not advantageous or obvious for this purpose.

For example, US 2016/146534A1 discloses a process comprising the steps of: Treating a feed stream to obtain a treated gas stream; at least partially cooling and condensing the treated gas stream in at least one heat exchanger in order to form at least one column feed fraction; feeding the at least one column feed fraction to a distillation column in order to recover an ethylene stream at the bottom of the distillation column and an ethylene-depleted head stream at the top; and heating at least one downstream stream derived from the head stream in the heat exchanger. As explicitly stated in this publication, this process is not directed to the processing of a product stream of a steam cracker, but to other ethylene sources that provide a feed stream of widely varying composition. The feed stream is explicitly obtained from nonconventional ethylene sources and not through a high temperature cracking process of hydrocarbons in the presence of steam.

WO 01/25174 A1 proposes a process for the concentration and production of ethylene and heavier components from an oxygenate conversion process. A separation process, such as a pressure swing adsorption (PSA) process, is used to remove hydrogen and methane from a demethanizer head stream containing hydrogen, methane and C2 hydrocarbons, and subsequently return the recovered C2 hydrocarbons to be admixed with the effluent from the oxygenate conversion process. This integration of a separation zone with a fractionation scheme in an ethylene production scheme using an initial deethanizer zone is intended to save capital and operating costs by eliminating cryogenic ethylene-based refrigeration from the overall production scheme.

Embodiments of processes and apparatuses for recovering ethylene from FCC absorber off-gas comprising a heavy fraction comprising ethylene, ethane and heavier hydrocarbons and a light fraction comprising hydrogen, nitrogen, and methane are described in WO 2016/204977A1. An exemplary process comprises passing the FCC absorber off-gas to an adsorption zone containing an adsorbent selective for adsorption of the light fraction, wherein the adsorption zone adsorbs at least a portion of the light fraction and recovers an adsorption zone effluent stream comprising the heavy fraction. The adsorption zone effluent is passed to a demethanizer column to provide an overhead stream comprising hydrogen, nitrogen, methane, ethylene and ethane, and a net bottoms stream comprising ethylene, ethane and the heavier hydrocarbons.

### SUMMARY

Against this background, an object of the invention is to simplify the demethanization in the course of a processing sequence for recovering fractions from a component mixture obtained by steam cracking, and to design it in an advantageous manner in terms of the apparatus.

This object is achieved by a process for the production of hydrocarbons by steam cracking and the preparation of a component mixture obtained thereby, along with a corresponding plant.

### BRIEF DESCRIPTION OF THE DRAWINGS

FIG. 1 shows a process, which can form the basis of one embodiment of the invention, in the form of a schematic process flow diagram.

FIG. 2 shows a process according to one embodiment of the invention in the form of a schematic process flow diagram.

### DETAILED DESCRIPTION

Prior to explaining the advantages of the invention, some terms used in describing the invention are defined in more detail below.

Component mixtures, in the language as used herein, can be rich or poor in one or more components, wherein the term “rich” can mean a content of at least 75%, 80%, 90%, 95% or 99% and the term “poor” can mean a content of at most 25%, 20%, 10%, 5% or 1% on a molar, weight or volume basis. Component mixtures in the terminology used herein may also be enriched with or depleted of one or more components, wherein these terms refer to a corresponding content in another component mixture, using which the component mixture under consideration was formed. The component mixture under consideration is “enriched” if it has at least 1.5 times, 2 times, 5 times, 10 times, 100 times or 1,000 times the content of the designated component(s), and “depleted” if it has at most 0.75 times, 0.5 times, 0.1 times, 0.01 times or 0.001 times the content of the designated component(s). A component mixture “predominantly” containing one or more components is, in particular, rich in this or these components in the sense just discussed.

Here, when a component mixture is referred to as being “formed” using another component mixture, it is to be understood that the component mixture under consideration has at least some of the components contained in or forming the other component mixture. Forming one component mixture from another may comprise, for example, branching off a portion of the component mixture, adding one or more further components or component mixtures, chemically or physically reacting at least some components, along with heating, cooling, evaporating, condensing, etc. However, a “forming” of a component mixture from another component mixture can also comprise merely providing the other component mixture in a suitable form, such as in a vessel or conduit.

The application uses the terms “pressure level” and “temperature level” to characterize pressures and temperatures, which is supposed to mean that corresponding pressures and temperatures in a corresponding plant do not have to be used in the form of exact pressure or temperature values. Nonetheless, such pressures and temperatures typically fall within certain ranges, such as, for example, ± 1%, 5%, 10%, 20%, or 25% around an average value. Corresponding pressure levels and temperature levels can lie in disjointed ranges or in ranges which overlap one another. The same pressure level can also be present, for example, if unavoidable pressure losses occur. The same applies to temperature levels. The pressure levels indicated here in bar are absolute pressures.

For the design and specific embodiment of towers, columns and other separation apparatuses along with their fittings, as they can also be used within the scope of the application, reference is expressly made to relevant technical literature (see, for example, Sattler, K.: Thermische Trennverfahren: Grundlagen, Auslegung, Apparate, 3rd edition 2001, Weinheim, Wiley-VCH). In particular, corresponding separation apparatuses can have conventional separation trays, particularly in the form of structured sheets with drainage devices, or suitable packings.

If the term “demethanization” is used in the following, it is to stand in short for a separation step in which hydrocarbons having two, or two and more, carbon atoms are separated from lower boiling compounds, in particular methane and hydrogen, from a component mixture fed to the demethanization process, i.e. the mentioned “feed mixture.” Demethanization conventionally yields a fraction that contains hydrocarbons having two, or two and more, carbon atoms, depending on the composition of the feed mixture fed to the demethanization process, and is always poor in or free of lower-boiling components, particularly methane and hydrogen. Such fraction is typically obtained in a liquid state and is also referred to below as the “heavy fraction.” Demethanization further yields a fraction containing the mentioned lower boiling compounds and poor in or free of hydrocarbons having two, or two and more, carbon atoms. Such fraction is typically obtained in a gaseous state and is also referred to below as the “light fraction.”

The invention makes demethanization, which has just been explained again, much simpler in terms of the equipment. Also within the framework of the invention, the heavy and light fractions with the above-mentioned characteristics are ultimately obtained, but initially only the heavy fraction is recovered through low-temperature separation. In this context, a low-temperature separation process is understood to mean, in particular, a separation performed using a rectification column at a temperature level of -50 to-150° C., for example, at a temperature level of -60 to -100° C.

In low-temperature separation, a fraction is initially obtained as the further fraction which, in addition to the lower-boiling components mentioned, also contains considerable amounts of hydrocarbons having two carbon atoms and possibly also higher-boiling hydrocarbons. This fraction is also referred to below as the “first intermediate fraction.” Within the framework of the invention, therefore, a “fuzzy” separation is carried out in demethanization, substantially ensuring that the heavy fraction (typically obtained in the bottom of a separation column used with the mentioned low-temperature separation) is sufficiently pure of lower-boiling components, wherein, however, the further obtained fraction, i.e., the first intermediate fraction (which, according to the invention, is obtained at least in part at the top of a separation column used in the mentioned low-temperature separation process) can still contain a corresponding or appreciable fraction of higher-boiling compounds.

In other words, it is accepted within the framework of the invention that substantial fractions of hydrocarbons having two or even two and more carbon atoms pass from the feed mixture into the first intermediate fraction. In order to nevertheless obtain both mentioned fractions (i.e., the light fraction as well), in a downstream non-cryogenic separation step, particularly an adsorptive separation step such as pressure swing adsorption (PSA), the first intermediate fraction is eventually separated into the light fraction and a further fraction, which is also referred to here as the “second intermediate fraction.” The second intermediate fraction is obtained at the desorption pressure level of pressure swing absorption, which is a lower pressure level than that at which low-temperature separation is performed to recover the heavy fraction and the first intermediate fraction. Thereby, the second intermediate fraction contains not only the hydrocarbons having two or also two and more carbon atoms, but also an unseparated fraction of the lower-boiling components, and can advantageously be recycled to the raw gas compression and fed again to low-temperature separation used to recover the heavy fraction and the first intermediate fraction.

A particularly preferred embodiment of the invention comprises expanding, heating and recycling a part of the condensates typically formed entirely in the demethanization process. In this manner, such part can be used as an additional refrigerant.

As a whole, to achieve the specified advantages, the invention proposes a process for the production of hydrocarbons, wherein a component mixture containing the hydrocarbons is provided. Using at least a portion of this component mixture, a further component mixture containing hydrocarbons having two, or two and more, carbon atoms and lower boiling compounds is provided. This is referred to here as a “feed mixture,” as mentioned, since it serves as a feed for the process steps essential to the invention. In the formation of the feed mixture, all processes and process steps known for the treatment of raw or cracked gases from a steam cracker, particularly those explained below, which result in a component mixture composed in the manner explained, may be used. The invention is not limited hereby. In particular, the feed mixture can comprise 10 to 60 mole percent hydrogen, 5 to 40 mole percent methane, and otherwise hydrocarbons having two, or two and more, carbon atoms. For example, the content of hydrocarbons having two carbon atoms can be from 30 to 60 mole percent. Since, as mentioned, the feed mixture can be formed using different further process steps, and moreover, within the framework of the invention, the second intermediate mixture can be recycled to the process, the composition of the component mixture can vary considerably. For example, within the framework of the invention, methane is recycled and accumulates in the cycle in this manner. In particular, the specified values are to be understood as the broadest limits.

Using the feed mixture, a heavy fraction and a light fraction are also ultimately formed within the framework of the invention, wherein the heavy fraction contains a portion of the hydrocarbons having two, or two and more, carbon atoms from the feed mixture and is poor in or free of the lower boiling components, and wherein the light fraction contains a portion of the lower boiling components from the feed mixture and is poor in or free of the hydrocarbons having two, or two and more, carbon atoms. Thus, these are fractions whose composition corresponds to the fractions formed in known demethanization devices, but which are formed in a manner that differs from the prior art and, in particular, in a simplified manner, as explained below.

According to the invention, the process comprises providing the component mixture at least in part by steam cracking, i.e. as a so-called “raw” or “cracked gas.” According to the invention, the heavy fraction and a first intermediate fraction are formed in a low-temperature separation process, which can also comprise further separation steps, using at least a portion of the feed mixture. At least a portion of the first intermediate fraction is subjected to a non-cryogenic separation process, in particular the mentioned pressure swing adsorption, while obtaining the light fraction and a second intermediate fraction, and at least a portion of the second intermediate fraction is recycled to the process. The non-cryogenic separation process is downstream of the low-temperature separation process, wherein the term “downstream” in this connection means in particular that no components of the feed mixture, or only a fraction of less than 50%, 25%, 10%, 5% or 1% thereof, enter the non-cryogenic separation process without having previously passed through the cryogenic separation.

The proposed process is applied in particular to a gas mixture that is provided at least in part by steam cracking a gaseous feed mixture, wherein a gaseous feed mixture as understood here comprises in particular more than 50% or more than 80% ethane, propane and/or butane (as individual component(s) or in total). A gas mixture obtained in this manner by steam cracking, in contrast to gas mixtures obtained by other processes, has comparatively large fractions of hydrogen and hydrocarbons having two and more than two carbon atoms and comparatively small amounts of methane, carbon dioxide and carbon monoxide. More generally, a gas mixture processed according to the invention can have a ratio between a first fraction formed by hydrogen and hydrocarbons having two and more than two carbon atoms (“C2plus” in Table 1 below) and a second fraction formed by methane, carbon dioxide and carbon monoxide of greater than 2, and/or the first fraction can be at least two-thirds of the total gas mixture (each expressed as a molar fraction). Preferably, the mentioned ratio is greater than 5 or greater than 10.

A suitable gas mixture processed according to the invention can alternatively be characterized by the ratio between a fraction formed by hydrogen and a fraction formed by methane, carbon dioxide and carbon monoxide. This ratio is in particular greater than 0.2 and further in particular greater than 2, for example greater than 5. Corresponding gas mixtures can be formed not only by steam cracking gaseous feeds, but particularly not by processes such as oxidative dehydrogenation, in which no hydrogen at all is contained in the product mixture. In the steam cracking of ethane, the content of carbon monoxide and carbon dioxide is in the ppm range, the content of methane is comparatively low, and the content of hydrogen is very high.

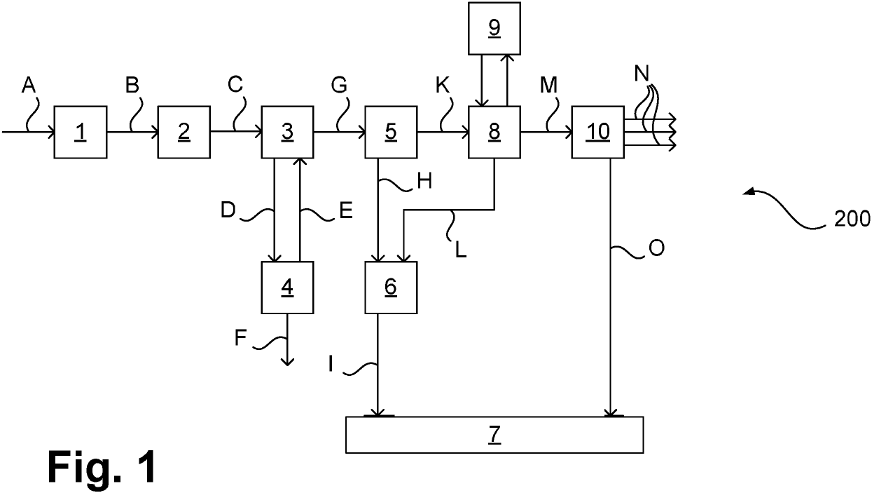

Table 1 below gives an exemplary overview of gas mixtures obtained by steam cracking of ethane and liquid feeds (see stream B in FIG. 1), wherein, in each case, only the content without water dilution or without the water content (i.e., based on the “dry cracked gas”), in particular based on the hydrocarbon content, is given.

TABLE 1

| | Ethane feed | Liquid feed |
|---|---|---|
| | mol/mol | |
| H₂/[CO + CO₂ + CH₄] | 5.1 | 0.6 |
| [H₂ + C2plus] / [CO + CO₂ + CH₄] | 13.1 | 2.8 |
| | mol% | |
| Hydrogen | 36.0 | 15.9 |
| Carbon monoxide, carbon dioxide | 0.04 | 0.06 |
| Methane | 7.1 | 26.0 |
| Acetylene | 0.3 | 0.6 |
| Ethylene | 33.7 | 28.9 |
| Ethane | 21.1 | 4.5 |
| C3plus | 1.7 | 24.0 |
| Total | 100 | 100 |

The measures proposed according to the invention are particularly advantageous for corresponding gas mixtures, particularly for those originating from steam cracking of gaseous feeds.

As noted above, according to the invention, non-cryogenic separation is downstream of low-temperature separation. Thus, the intention is to use non-cryogenic separation to “recover” the fraction containing hydrocarbons having two or more carbon atoms and to separate the lighter components from it as “effectively” as possible. This is only partially successful because, as will be explained elsewhere, the heavier fraction formed in the non-cryogenic separation process is used, for example, to drive methane around in circles to a considerable extent. However, the lighter the component, the better the separation works. Therefore, the process is all the more suitable when there is a “concentration minimum” with methane, carbon dioxide and carbon monoxide, and comparatively many hydrocarbons having two or more carbon atoms (as the heaviest compounds) and hydrogen (as the lightest compound). In such a scenario, cold separations become all the more difficult and thus the invention is particularly advantageous in comparison.

In contrast to EP 1 024 187 A1 mentioned at the beginning, the specific arrangement of the low-temperature separation process and non-cryogenic separation process proposed according to the invention is thus particularly advantageous and represents a non-obvious advantageous alternative. Compared to publications such as US 2016/146534A1, WO 01/25174A1 and WO 2016/204977A1, for example, the invention relates to a different technical field and offers advantages particularly in this respect.

The first and second intermediate fractions each contain, but possibly in different compositions due to the intermediate non-cryogenic separation process, a portion of the hydrocarbons having two, or two and more, carbon atoms and of the lower boiling compounds from the feed mixture. Thus, the hydrocarbons having two, or two and more, carbon atoms do not have to be completely separated in the low-temperature separation process, as already mentioned, which in particular reduces the apparatus required for the separation. In the subsequent non-cryogenic separation process, in turn not all lower boiling compounds necessarily have to be separated, since the second intermediate fraction can be fed back to the cryogenic separation. However, by combining both separation steps, the feed mixture can eventually be completely separated into the fractions whose compositions correspond to the fractions formed in known demethanization devices.

Typically, as mentioned, temperatures below -130 to -150° C. are required for demethanization in known processes. In the course of the invention, temperatures between -60° C. to -100° C. are sufficient. This eliminates the need for costly low-temperature refrigeration measures such as expanders/boosters. With a subsequent embodiment of the invention, with which a portion of condensates formed from the feed mixture is expanded, heated and recycled for compression, external refrigeration below -40° C. is not required.

The separation column used within the framework of the invention can be operated without a condenser or overhead condenser and requires a significantly smaller number of theoretical or practical separation trays, which represents a further structural simplification. Further, within the framework of the invention, the light fraction accumulates at high pressure, specifically substantially the adsorption pressure level of non-cryogenic separation if this is carried out as pressure swing adsorption. This enables simple hydrogen recovery without the need to compress this light fraction (as would usually be the case in the case of a gas cracker, i.e. while steam cracking gaseous feeds).

The process solution proposed according to the invention is particularly suitable for small plants, since it may be less attractive in terms of specific energy consumption, but has a lower number of apparatuses.

Upstream raw gas hydrogenation can be made much simpler within the framework of the invention (e.g., single-stage adiabatic instead of isothermal), since dilution of the raw gas or feed mixture is accomplished with the second intermediate mixture recycled from the non-cryogenic separation step, such as pressure swing adsorption. If one further generates refrigeration with the raw gas compressor, i.e. in the embodiment of the invention, with which a portion of condensates formed from the feed mixture is expanded, heated and recycled for compression, the dilution is even more pronounced.

By using the invention, no return pump is required. In addition, the operating pressure of the separation column is so high that no sump pump is required when a downstream high-pressure C2 splitter is selected to separate the hydrocarbons having two carbon atoms, i.e., ethane and ethylene, from one another. This is important and particularly advantageous if the process is to be designed without a so-called “C2 machine.”

Due to the lower cooling (for example -60° C. instead of -100° C. in conventional demethanization), fewer individual cooling steps are required within the framework of the invention, and the apparatus required for cooling and partial condensation can be arranged much more simply, for example in a cold box. Due to the low number of trays in the column and the fact that there is no need for an overhead condenser, it may also be possible to accommodate the column in a common cold box.

Compared with processes for separating corresponding component mixtures from other processes, such as for example the oxidative dehydrogenation of ethane, which are much lower in hydrogen or free of hydrogen, in the present case cooling must in any case be lower than -40° C. (e.g., -60° C.) due to the increased hydrogen concentration, such that a process such as that disclosed in EP 3 456 703 A1, for example, cannot be transferred to the present case.

In particular, non-cryogenic separation can take the form of adsorptive separation, in particular a pressure swing adsorption. For pressure swing adsorption, any process and arrangement known in the prior art with multiple parallel adsorber vessels can be used. For example, the pressure swing adsorption can be operated at an inlet or adsorption pressure level that is at the operating pressure level of the separation column, such that, as mentioned, the light fraction obtained is at a pressure level advantageous for subsequent hydrogen recovery. In processes for the oxidative dehydrogenation of ethane, this is not relevant, because hydrogen is not or hardly contained in the product mixtures obtained there.

Within the framework of the invention, as known per se, the provision of the feed mixture advantageously comprises the compression of at least a portion of the component mixture formed by the steam cracking, in particular in a so-called raw gas compressor. Advantageously, at least a portion of the second intermediate fraction is recycled to the process upstream of the compressor and is compressed therein. This allows this second intermediate fraction to be able to be subjected to separation again without providing a separate compressor, such that components not initially separated are not lost.

Advantageously, the provision of the feed mixture comprises precooling, drying and/or hydrogenation. At least partial removal of hydrocarbons having three or three and more carbon atoms can be performed within the framework of the invention prior to demethanization or after demethanization (i.e., from the bottoms product). As mentioned, all apparatus and process steps, as they are known and customary for the processing of cracked or raw gas, can be used.

Within the framework of the invention, in low-temperature separation, one or more condensates are formed using one or more cooling apparatuses, in particular a countercurrent heat exchanger, and one or more separation apparatuses, in particular simple separation vessels, and at least a portion of the one or more condensates is separated in a separation column that, as mentioned, can advantageously be simplified, i.e. with a smaller number of separation trays and without an overhead condenser, and thus be formed in the manner of a stripping column. Thereby, the formation of the condensates themselves can be carried out in the usual manner.

In particular, forming the one or more condensates using the one or more cooling apparatuses and the one or more separation apparatuses comprises cooling in a single stage or stepwise manner to a temperature level of -60 to -80° C., for example approximately -70° C. This is the lowest temperature level to which components must be cooled within the framework of the invention. Therefore, in contrast to the prior art, much simpler devices can be used to provide refrigerants. Optionally, however, it can also be cooled down even further, for example to -100° C., provided, for example, that corresponding refrigerants are already available in the plant without additional effort.

Advantageously, within the framework of the invention, at least a portion of a residue and/or an overhead gas of the separation column remaining gaseous during the formation of the one or more condensates using the one or more cooling apparatuses and the one or more separation apparatuses is used at least in part to form the first intermediate fraction.

In one embodiment of the invention, advantageously, at least a portion of the first intermediate fraction is heated using the one or more cooling apparatuses used in forming the one or more condensates before being fed to the non-cryogenic separation process. In this manner, the contained cold can be used for the formation of the condensates. A further, particularly advantageous embodiment comprises using a portion of the one, or at least one, of the plurality of condensates as a refrigerant, i.e., expanding such portion, thereafter heating such portion using the one or more cooling apparatuses used in forming the one or more condensates, and compressing such portion, in particular using the specified (raw gas) compressor, and thereafter recycling such portion to the process upstream of the compression. In this manner, a cycle is formed with which refrigerant is formed in the process itself and used for condensation. The advantage is that the need for external refrigerant is reduced, or its required temperature can be higher.

The formation of the one or more condensates using the one or more cooling apparatuses and the one or more separation apparatuses is advantageously carried out at a pressure level of 25 to 40 bar, and the separation column is advantageously operated at a pressure level of 20 to 35 bar, i.e. at an only slightly lower pressure level. The pressure difference is advantageously less than 10 or 5 bar.

Advantageously, a further refrigerant is also passed through the one or more cooling apparatuses which, in the case of the use of condensate for refrigerant production in a corresponding embodiment of the invention, can be a further refrigerant at, for example, approximately -40° C. or, in other cases, a refrigerant at, for example, approximately -70 to -100° C. In other words, with condensate recirculation, propylene refrigeration is sufficient and without condensate recirculation, ethylene refrigeration in particular is required.

The plant according to the invention for recovering hydrocarbons has means that are configured to provide a component mixture and to provide, using at least a portion of the component mixture, a feed mixture that contains hydrocarbons having two or more carbon atoms and lower boiling compounds, means that are configured to form, using the feed mixture, a heavy fraction and a light fraction, wherein the heavy fraction contains a portion of the hydrocarbons having two or more carbon atoms from the feed mixture and is poor in or free of the lower boiling components, and wherein the light fraction contains a portion of the lower boiling components from the feed mixture and is poor in or free of the hydrocarbons having two or more carbon atoms.

According to the invention, the plant has means that are configured to provide the component mixture at least partly by steam cracking, and a low-temperature separation is provided which is formed and operated such that the heavy fraction and a first intermediate fraction are formed therein using at least a portion of the feed mixture. Further provided is non-cryogenic separation downstream of the low-temperature separation process, in particular as explained above, and configured to process at least a portion of the first intermediate fraction to obtain the light fraction and a second intermediate fraction, along with means that are configured to recycle at least a portion of the second intermediate fraction to the process, wherein the first and second intermediate fractions each contain a portion of the hydrocarbons having two, or two and more, carbon atoms and the lower boiling compounds from the feed mixture.

With regard to features and advantages of a corresponding plant, which advantageously has means which enable it to perform a process in the embodiments explained above, reference is expressly made to the above explanations.

Embodiments of the invention are explained in more detail below with reference to the accompanying drawings.

In the figures, elements functionally or structurally corresponding to one another are indicated by reference signs corresponding to one another and are not explained repeatedly for the sake of clarity. The following explanations relate to processes and corresponding plants in the same manner. It is understood that, in practice, corresponding plants or processes may also comprise optional or mandatory further components or process steps. These are not shown in the figures, solely for the sake of clarity.

FIG. 1 illustrates a process that can form the basis of one embodiment of the invention in the form of a schematic process flow diagram. The overall process is designated as 200. Thereby, the invention can be used with the illustrated process, but also with any other process of known type. In particular, with respect to the receipt and treatment of the pyrolysis oil and pyrolysis gasoline, one embodiment of the invention may differ, since in particular ethane is used here as a feed for steam cracking and therefore pyrolysis oil may not be produced or may be produced to a much lesser extent.

In the process 200, one or more hydrocarbons or hydrocarbon mixtures A, in particular ethane, are subjected to steam cracking 1 together with steam. The hydrocarbons are at least partially thermally cracked. One or more crackers of known type can be used for steam cracking 1.

Steam cracking 1 yields a component mixture B, which is subjected to a quench 2. After quench 2, the component mixture, now designated with C, is fed to oil removal 3. In oil removal 3, if contained in component mixture C, pyrolysis oil D is separated from component mixture C in one or more fractions.

In the shown example, the pyrolysis oil D is subjected to oil stripping 4 in order to recover lighter compounds E deposited with the pyrolysis oil D. These are recycled to oil removal 3. The remaining residue F of the pyrolysis oil D can be recycled as a return flow to oil removal 3 and removed from the process 100 as a product in the form of cracked oil. Additionally or alternatively, pyrolysis oil D not subjected to oil stripping 4 can be recycled to oil removal 3 as a return flow.

Any residue G of the component mixture C remaining after oil removal 3, or the entire component mixture C if no oil removal 3 takes place, is fed to gasoline removal 5, the presence and design of which also depends on the content of pyrolysis gasoline in the component mixture C. In gasoline removal 5, (heavy) pyrolysis gasoline H is separated.

In the shown example, the heavy pyrolysis gasoline H is at least partially fed to gasoline stripping 6 in order to remove light components. The latter may be withdrawn from the process or recycled to the process at an appropriate point. A portion of the heavy pyrolysis gasoline H can be recycled to oil removal 3 before and/or after gasoline stripping 6.

The stripped pyrolysis gasoline obtained in gasoline stripping 6, now designated with I, is fed to the so-called gasoline path 7, which is not explained in detail here. It can also be provided that a portion of the heavy pyrolysis gasoline H is fed directly to the gasoline path 7 without stripping.

In the example shown, any residue K of the component mixture G remaining after gasoline removal 5 or, if gasoline removal 5 is not provided, also the entire component mixture G, is fed to in particular multi-stage compression 8, so-called raw gas compression, in the course of which acid gas removal 9 can be carried out. Further pyrolysis gasoline L can be separated in raw gas compression 6, which can also be fed to gasoline stripping nit 6 or directly to the gasoline path 7, for example.

The compressed component mixture M freed of acid gases is fed to fractionation 10 in which several fractions are formed, illustrated here by N as an example. Fractionation can be performed using any apparatus. Fractions N comprise, for example, fractions containing predominantly or exclusively compounds with two, three, four or more than four carbon atoms, or corresponding collection fractions, or specific hydrocarbons such as ethane or ethylene. The fractions N are fed to a suitable use. Their formation, in turn, depends on the hydrocarbons subjected to steam cracking 1 and thus on the corresponding contents in the component mixture B.

Further pyrolysis gasoline O can be formed in fractionation 10, but advantageously this is not fed to gasoline stripping 6. The pyrolysis gasoline can be supplied to the gasoline path 7 at another point, for example.

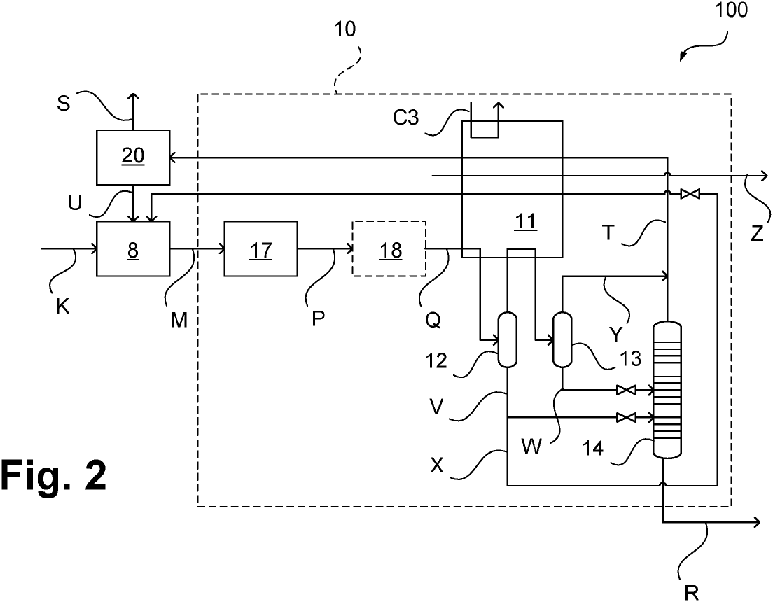

FIG. 2 illustrates a process according to a preferred embodiment of the invention in the form of a schematic process flow diagram. The overall process is designated with 100. In particular, it can be integrated into the process 200 according to FIG. 1 or a comparable process, wherein the integration results in particular from the illustration and corresponding designation of the material flows K and M and the compression unit 8. The illustration according to FIG. 2 thus corresponds in particular to a partial illustration of the process 200 from FIG. 1 or another similarly or differently designed process, wherein further components result at least in part from the illustration of the process 200 according to FIG. 1.

The fractionation process, which takes the form of a low-temperature separation process 10, is illustrated in more detail here. In particular, it comprises pre-cooling, drying and raw gas hydrogenation 17. All components can be formed in a manner customary in the art. The raw gas hydrogenation can also be omitted, in particular if individual fractions are hydrogenated subsequently.

The correspondingly treated component mixture, now designated with P, can be fed to optionally provided deethanization 18, in which case, using at least a portion of the component mixture P, and thus also using at least a portion of the component mixture B, a further component mixture Q, referred to here as the “feed mixture,” is provided, which contains hydrocarbons having two carbon atoms and lower-boiling compounds, but not hydrocarbons having three or more carbon atoms. If deethanization 18 is not used, a corresponding feed mixture can also contain hydrocarbons having more than three carbon atoms.

Using the feed mixture, a heavy fraction R and a light fraction S are formed, wherein the heavy fraction contains a portion of the hydrocarbons having two, or two and more, carbon atoms from the feed mixture Q and is poor in or free from the lower boiling components, and wherein the light fraction S contains a portion of the lower boiling components from the feed mixture Q and is poor in or free from the hydrocarbons having two, or two and more, carbon atoms.

In the embodiment of the invention illustrated herein, the heavy fraction R and a first intermediate fraction T are formed in low-temperature separation 10 using at least a portion of the feed mixture Q. At least a portion of the first intermediate fraction T is further subjected to non-cryogenic separation 20, in particular pressure swing adsorption, to obtain the light fraction S and a second intermediate fraction U. The second intermediate fraction U is recycled to the process 100, and in the example shown, upstream of compression 8, where it is also accordingly compressed. As mentioned several times, the first intermediate fraction T and the second intermediate fraction U each contain a portion of the hydrocarbons having two, or two and more, carbon atoms and the lower-boiling compounds from the feed mixture Q.

In low-temperature separation 10, condensates V and W are formed using one or more cooling apparatuses 11 in the form of a countercurrent heat exchanger and two separation apparatuses 12, 13 in the form of separation vessels. A portion of the condensate V is expanded in the form of a material flow X, recycled through the cooling apparatus 11, heated there, and fed back to the compression process. The material flow X thus serves as the refrigerant produced in the process. The remaining residue of the condensate X and the total condensate W are subjected to separation in a separation column 14. Here, the formation of the condensates of the cooling apparatus 11 and the separation apparatuses 12, 13 comprises a two-stage cooling down to a temperature level of, for example, approximately -70° C. and takes place at a pressure level of, for example, approximately 25 to 40 bar. The separation column 14 is operated at a pressure level of, for example, approximately 20 to 35 bar, such that the condensates V and W or their fractions fed into the separation column 14 are passed through corresponding control valves, which are not separately designated, and, if necessary, expanded. Here, it is only essential that the pressure level of the feed mixture Q is high enough such that sufficient condensate formation occurs in the cooling apparatus 11, and that the pressure level of the separation column 14 is high enough such that the subsequent separation process 20 can still be operated effectively. In one embodiment, the two pressure levels are nearly identical or just different enough that condensates V and W can be fed into the separation column 14 without the need for additional equipment such as pumps.

At least a portion of a residue remaining in gaseous form upon the formation of condensates V and W using the cooling apparatus 11 and the separation apparatuses 12, 13, illustrated here in the form of a material flow Y, and an overhead gas of the separation column 14, which is not separately designated, are used in the example shown to form the first intermediate fraction, i.e., the material flow T. The material flow T is thereby heated using the cooling apparatus 11 used in forming the condensates V and W before being fed to the non-cryogenic separation process 20. The cooling apparatus 11 is also operated using a suitable refrigerant C3, for example low-pressure propylene.

If necessary or advantageous for the overall process 200, other material flows may also be used as refrigerants in the cooling apparatus 11. Additionally, other material flows not directly related to the process 100 may be cooled or condensed. In the shown example, a liquid ethylene product stream Z is cooled to the same temperature level as condensate W.

1. A process for the production of hydrocarbons, comprising:
providing a component mixture containing the hydrocarbons at least in part by steam cracking;
providing a feed mixture containing hydrocarbons having two, or two and more, carbon atoms and lower boiling compounds using at least a portion of the component mixture; and
forming a heavy fraction and a light fraction using the feed mixture, wherein:
the heavy fraction contains a portion of the hydrocarbons having two, or two and more, carbon atoms from the feed mixture and is poor in or free from the lower boiling components;
the light fraction contains a portion of the lower boiling components from the feed mixture and is poor in or free from the hydrocarbons having two, or two and more, carbon atoms;
the heavy fraction and a first intermediate fraction are formed in a low-temperature separation process using at least a portion of the feed mixture;
at least a portion of the first intermediate fraction is subjected to a non-cryogenic separation process while obtaining the light fraction and a second intermediate fraction;
the non-cryogenic separation process is downstream of the low-temperature separation process;
at least a portion of the second intermediate fraction is recycled to the process;
the first and second intermediate fractions each contain a portion of the hydrocarbons having two, or two and more, carbon atoms and the lower boiling compounds from the feed mixture.

2. The process according to claim 1, wherein an adsorptive separation process, in particular a pressure swing adsorption, is used as non-cryogenic separation.

3. The process according to claim 1, wherein providing the feed mixture comprises compressing at least a portion of the component mixture formed by the steam cracking.

4. The process according to claim 3, wherein at least a portion of the second intermediate fraction is recycled to the process upstream of said compression and is compressed therein.

5. The process according to claim 4, wherein the provision of the feed mixture comprises pre-cooling, drying and/or hydrogenation and/or at least partial removal of hydrocarbons having three or three and more carbon atoms.

6. The process according to claim 5, wherein the low-temperature separation process comprises forming one or more condensates using one or more cooling apparatuses and one or more separation apparatuses, and separating at least a portion of the one or more condensates in a separation column.

7. The process according to claim 6, wherein forming the one or more condensates using the one or more cooling apparatuses and the one or more separation apparatuses comprises single-stage or multi-stage cooling to a temperature level of -60 to 80° C.

8. The process according to claim 7, wherein at least a portion of a residue remaining in gaseous form upon the formation of the one or more condensates using the one or more cooling apparatuses and the one or more separation apparatuses and/or an overhead gas of the separation column is used at least in part to form the first intermediate fraction.

9. The process according to claim 8, wherein at least a portion of the first intermediate fraction is heated using the one or more cooling apparatuses used in forming the one or more condensates before being fed to non-cryogenic separation.

10. The process according to claim 17, wherein a portion of the one, or at least one, of the plurality of condensates is expanded, thereafter heated using the one or more cooling apparatuses used in forming the one or more condensates, and thereafter compressed and recycled to the process.

11. The process according to claim 17, wherein the formation of the one or more condensates using the one or more cooling apparatuses and the one or more separation apparatuses is performed at a pressure level of 25 to 40 bar, and wherein the separation column is operated at a pressure level of 20 to 35 bar.

12. The process according to claim 1, wherein a refrigerant is passed through the one or more cooling apparatuses.

13. A plant for the production of hydrocarbons, comprising:
means configured to provide a component mixture containing the hydrocarbons;
providing, using at least a portion of the component mixture, a feed mixture that contains hydrocarbons having two, or two and more, carbon atoms and lower boiling compounds and
means configured to form, using the feed mixture, a heavy fraction and a light fraction, wherein the heavy fraction contains a portion of the hydrocarbons having two, or two and more, carbon atoms from the feed mixture and is poor in or free from the lower boiling components, and wherein the light fraction contains a portion of the lower boiling components from the feed mixture and is poor in or free from the hydrocarbons having two, or two and more, carbon atoms;
wherein the plant has:
means configured to recover the component mixture containing the hydrocarbons at least partly by steam cracking;
a low-temperature separation unit that is formed and operated such that the heavy fraction and a first intermediate fraction are formed therein using at least a portion of the feed mixture; and
a non-cryogenic separation unit is downstream of the low-temperature separation unit and is configured to process at least a portion of the first intermediate fraction to obtain the light fraction and a second intermediate fraction; and
means configured to recycle at least a portion of the second intermediate fraction to the process;
wherein the first and second intermediate fractions each contain a portion of the hydrocarbons having two, or two and more, carbon atoms and the lower boiling compounds from the feed mixture.

14. The plant according to claim 13, which is configured to perform a process according to claim 1.

15. The process according to claim 2, wherein providing the feed mixture comprises compressing at least a portion of the component mixture formed by the steam cracking.

16. The process according to claim 1, wherein the provision of the feed mixture comprises pre-cooling, drying and/or hydrogenation and/or at least partial removal of hydrocarbons having three or three and more carbon atoms.

17. The process according to claim 1, wherein the low-temperature separation process comprises forming one or more condensates using one or more cooling apparatuses and one or more separation apparatuses, and separating at least a portion of the one or more condensates in a separation column.

18. The process according to claim 17, wherein forming the one or more condensates using the one or more cooling apparatuses and the one or more separation apparatuses comprises single-stage or multi-stage cooling to a temperature level of -60 to -80° C.

19. The process according to claim 18, wherein at least a portion of a residue remaining in gaseous form upon the formation of the one or more condensates using the one or more cooling apparatuses and the one or more separation apparatuses and/or an overhead gas of the separation column is used at least in part to form the first intermediate fraction.

20. The process according to claim 19, wherein at least a portion of the first intermediate fraction is heated using the one or more cooling apparatuses used in forming the one or more condensates before being fed to non-cryogenic separation.
